(19) United States
(12) Patent Application Publication
(10) Pub. No.: US 2015/0339750 A1
(43) Pub. Date: Nov. 26, 2015

(54) METHOD FOR RETRIEVING AND PRESENTING TRAVEL RELATED INFORMATION

(71) Applicant: David WOLKIN, Santa Clara, CA (US)

(72) Inventor: David WOLKIN, Santa Clara, CA (US)

(21) Appl. No.: 14/818,193

(22) Filed: Aug. 4, 2015

Related U.S. Application Data
(62) Division of application No. 12/247,389, filed on Oct. 8, 2008.
(60) Provisional application No. 61/023,326, filed on Jan. 24, 2008.

(51) Int. Cl. G06Q 30/06; G06Q 50/14

(52) U.S. Cl. CPC G06Q 30/0623; G06Q 50/14

(57) ABSTRACT

A method to intuitively and quickly retrieve travel related information and gain access to providers of travel related services. The method is especially suitable for quickly finding non-stop airplane flights and connecting to airline reservation systems in as few as two clicks to access an airline reservation system to book a non-stop airplane flight. A user selects points such as airports on map-based displays and is presented with information pertaining to travel between, and services near, the selected points, such as airlines, lodging, car rentals, etc.

### CROSS-REFERENCE TO RELATED APPLICATION

Under 35 U.S.C. 120, this application is a Divisional Application and claims priority to U.S. patent application Ser. No. 12/247,389, entitled “Method for Retrieving and Presenting Travel Related Information,” filed Oct. 8, 2008, which claims priority from U.S. Provisional Patent Application Ser. No. 61/023,326, entitled “System and Method to Display and Retrieve Travel Related Information,” filed Jan. 24, 2008, all of which are hereby incorporated by reference in their entireties.

### TECHNICAL FIELD

The present invention relates generally to retrieving and presenting travel related information. More specifically, the invention relates to an intuitive and rapid display of graphical map-based travel information obtained via the Internet.

### BACKGROUND

As the Internet has grown, travel related service companies, particularly companies emphasizing air flights, have created websites for selling travel related services directly to consumers. Typically the websites are rigid, complex to use, not intuitive, offer limited information, and present the limited information in a manner that does not emphasize value or convenience. Websites typically charge fees, thus increasing costs to customers and not allowing access to an actual provider of the travel related service.

The websites offer a limited set of search results. Further, the websites offer only services which they can sell. In the case of air flights, search results are restricted to show only airlines with which the websites have made sales arrangements. The air flights shown are further restricted to only flights on those airlines that the websites currently have in their inventories to sell. Various discount airlines which do not allow outside agencies to sell passage on their flights cannot be accessed via the websites.

Also, travel related information, when presented, is not done in a manner that emphasizes convenience or value to the customer. In the case of air travel, lowest cost flights, which are usually the least convenient flights, are usually listed first on a long list of possible routes to reach a destination. Some of the possible routes have numerous stops, connection changes, and long total trip times. Flights with long trip times, airport layovers, and fares that are even one dollar less are initially ranked higher than flights which are more expensive but are more convenient non-stop flights with shorter trip times.

The websites frequently bundle travel packages, for example, hotels, car rental, and flights. Bundling makes it difficult for customers to learn separate prices of individual items. Bundling also raises the question of restrictive practices such as ‘racking’ which presents only what a travel company wishes to sell. Average customers, unaware of possible alternatives, think that the bundled travel packages are the only offerings available.

What is needed is a method capable of collecting travel related service information and presenting information on the most convenient and best value travel to the customer. Further, the method should facilitate and expedite the purchase of travel related services directly from the travel related service provider.

### SUMMARY

Travelers want the “best value,” the quickest and most convenient flight for their money. The present invention helps by showing all non-stop flights and all non-stop airlines including discount carriers that most sites omit. Often, a traveler can find a non-stop flight for less or just a little more than by enduring the hassle of connecting flights. The present invention makes it simple and quick to compare non-stop flights between airlines. A first click may be used to select an origin airport. Selection of the origin airport causes, among other things, the distinguishable indication of destination airports that receive non-stop flights from the origin airport and the corresponding destination airlines at the destination airports that offer the non-stop flights. A second click which may be used to select a destination airline may provide access to an airline reservation system providing schedules and pricing. When the traveler finds the “best value” flight, he or she may book it at the “Guaranteed Lowest Online Price.”

The present invention preferably provides information and “quick link” referrals to the traveler's choice of airline or other supplier such as rental cars, hotels, etc. In one embodiment, after seeing all their best options travelers preferably buy direct and get all the perks: frequent flier miles, lowest prices, and easier communication with the airline if travel plans require change. No complicating middle “agents” are involved.

Most other sites try to sell travelers the “lowest fare” (meaning the “most profitable” ticket to them) that they have available to sell at that moment. These sites often prefer to sell less convenient but more profitable connecting flights and de-emphasize non-stops. They also frequently omit discount carriers that often offer the quickest flight at the lowest price. Their search results are biased toward what they can sell—not what is advantageous for the traveler.

The present invention preferably shows all non-stop flights and all airlines without bias. The invention seeks to help travelers find and book the quickest, most convenient flight for their money. The present invention offers a “point and click” way to compare non-stop options (e.g., pricing and schedules) with a link to booking sites. A first and second click may be used to access an airline reservation system, a listing of links that may be used to access an airline reservation system, or any number of travel related resources. The present invention also offers a unique, clickable “Smart Index” of traveler services at more than three hundred airports which may include: rental cars, shuttle hotels, parking options (onsite/offsite), ground transportation, airport concessions, and maps.

An exemplary embodiment discloses a method to retrieve and present travel related information. Map-based displays of travel related information are updated based on captured end user input. The end user is provided access to travel related resources pertaining to the travel related information presented on the updated map-based displays.

### BRIEF DESCRIPTION OF THE DRAWINGS

FIG. 1 is an exemplary flowchart of a computer-based system to retrieve and present travel related information in accordance with an embodiment of the present invention.

FIG. 2 is an exemplary single-trip flowchart in accordance with the computer-based system of FIG. 1.

FIGS. 3A and 3B are exemplary multi-trip flowcharts in accordance with the computer based system of FIGS. 1 and 2.

FIG. 4 is an exemplary first map-based display of travel related information.

FIG. 5 is an exemplary second map-based display of travel related information.

FIG. 6 is an exemplary third map-based display of travel related information.

FIG. 7 is an exemplary listing of an airports summary.

FIG. 8 is an exemplary listing of an airlines summary.

FIG. 9 is an exemplary listing of a flights summary.

FIG. 10 is an exemplary multi-trip map-based display of travel related information.

### DETAILED DESCRIPTION

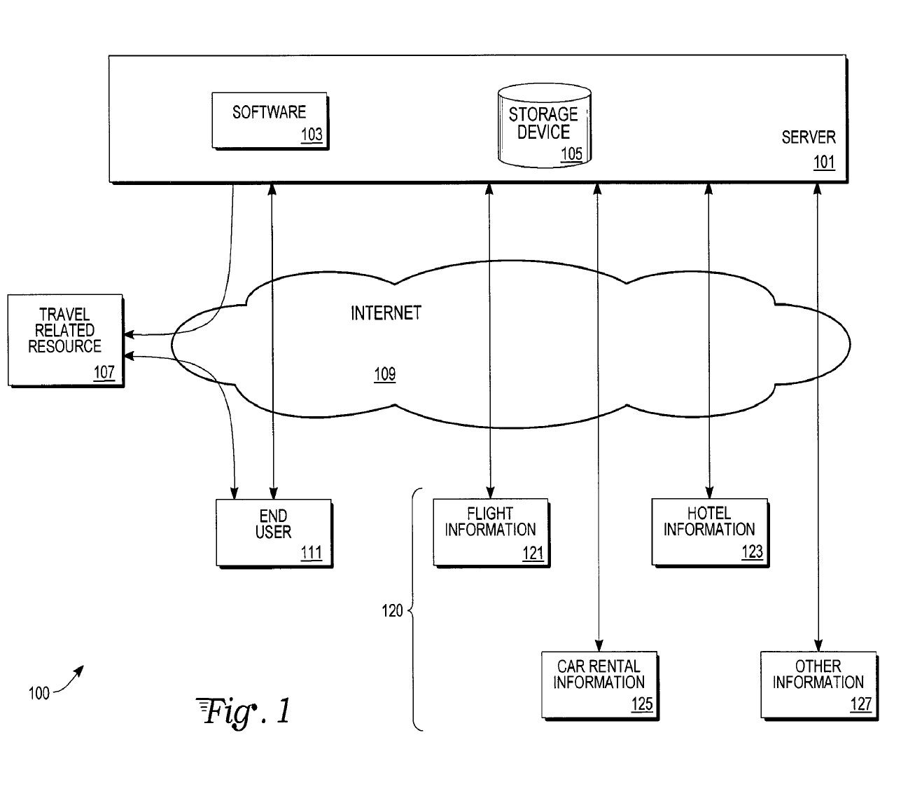

FIG. 1 is an exemplary schematic of a computer-based system 100 for retrieving and displaying travel related information and providing access to travel related resources in accordance with an embodiment of the present invention. The computer-based system 100 includes a server 101, a travel related resource 107, the Internet 109, an end user 111, and various sources of raw travel related information 120. The server 101 contains software 103 and a storage device 105. Specific exemplary embodiments may include a plurality of servers, software, and storage devices. Raw travel related information is collected by the server 101 from the sources of raw travel related information 120 and kept in the storage device 105. The raw travel related information may include flight information 121, hotel information 123, car rental information 125, and other information 127. The sources of raw travel related information 120 may include airports, airlines, hotel chains, automobile rental companies, and commercial databases. The server 101 uploads the raw travel related information over the Internet 109 from the sources of raw travel related information 120. Other embodiments may use other means of data transmission of the raw travel related information. The raw travel related information is updated periodically to remain current.

Software 103 is used to extract pertinent travel related information from the raw travel related information and keeps the pertinent travel related information in the storage device 105. The pertinent travel related information may include airline flight schedules, companies offering hotels and lodging at or near airports, automobile rental companies operating at or near airports, parking facilities at or near airports, or any other information pertaining to travel related services. In other embodiments, the extracted travel related information may include tourist attractions, taxi, limousine, and bus transportation companies operating at or near airports, and other pertinent travel related information. Pertinent travel related information is periodically extracted from the raw travel related information to insure that it remains current.

The end user 111 may access the server 101 through the Internet 109. A web browser (not shown) may be used by the end user 111 to access the server 101. The web browser may be any web browser such as Internet Explorer®, Firefox®, Internet Safari®, Opera Mobile™, or Netscape®. In other embodiments the end user 111 may use other web browsers or any means by which to display and interact with text, images, other information typically found on a web page, and information presented by the server 101 or a travel related resource 107. In other embodiments the server 101 may be accessed using various networks such as intranets, extranets, wireless networks, etc. When the end user 111 accesses the server 101, pertinent travel related information may be presented in various manners such as, for example, a map-based display/overview and a listing. A link to a travel related resource 107, which may be a reservation system of a provider offering a travel related service, may be included as part of the map-based display/overview (not shown) and the listing (not shown). The travel related resource 107 may be for providers of airline, hotel, car rental, parking, or any other travel related service. When accessing the travel related resource 107, information may be sent by the server 101 enabling the end user 111 to access a part of the travel related resource 107 related to specific travel requirements of the end user 111. For example, a part of an airline reservation system showing, among other things, non-stop flights between desired airports.

The end user 111 may obtain information, purchase services, or use any other features offered by the travel related resource 107. The server 101 may transmit information specific to the end user 111 to the travel related resource 107 when the end user 111 accesses the travel related resource 107. The information specific to the end user 111 may be personal information such as name, credit card number, address, telephone number, etc. The information specific to the end user may also be travel related such as a date of travel, a designated origin airport, a designated destination airport, etc.

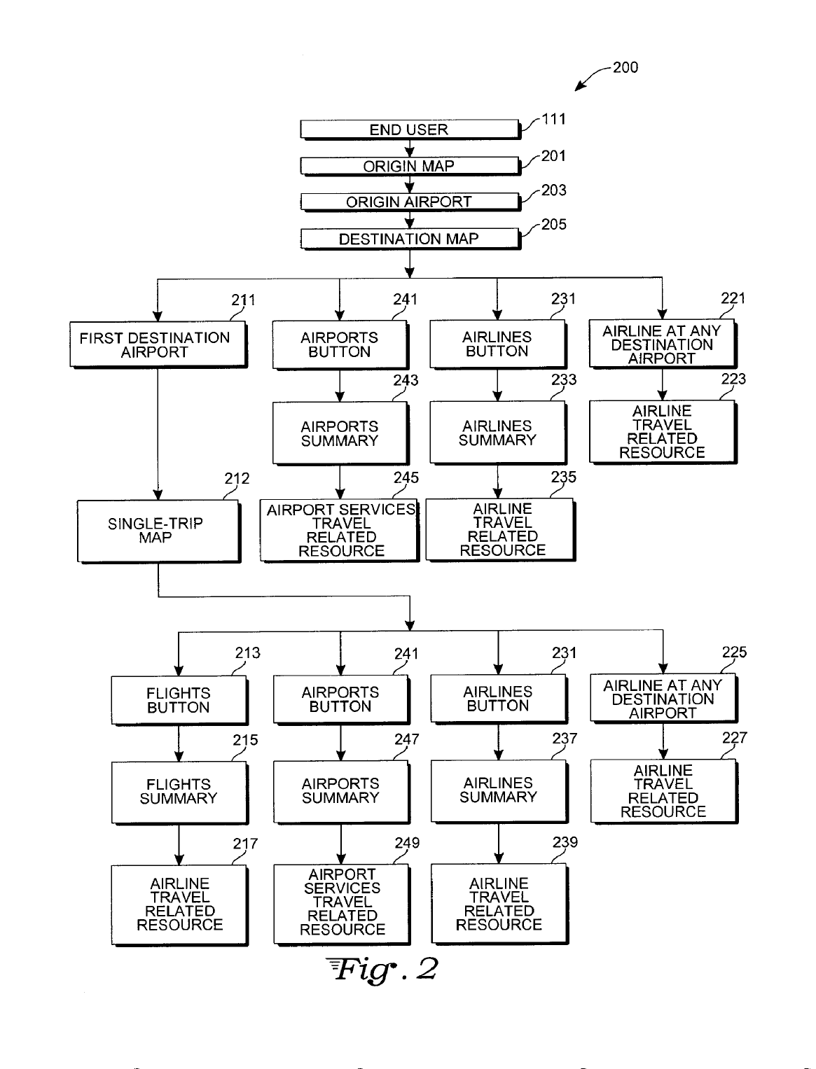

FIG. 2 is an exemplary single-trip flowchart 200 in accordance with the computer-based system 100 of FIG. 1. When the end user 111 accesses the server 101 (FIG. 1), the end user 111 is presented with a first map-based display of travel related origin information, an origin map 201. The origin map 201 predominantly displays a geographic area including airports found in the geographic area from which a flight may originate.

The end user 111 then selects an origin airport 203, for example, an airport appearing on the origin map 201, from which to begin a flight. Once the origin airport 203 has been selected, the end user 111 is presented with a second map-based display of travel related destination information, a destination map 205. Travel related information presented on the destination map 205 is specific to the origin airport 203 selected on the origin map 201. The destination map 205 predominantly displays a geographic area.

A prominent feature of the destination map 205, and all other maps except the origin map 201, is the distinguishable indication of what types of flights airports may receive from the origin airport 203 and airlines at the airports that may receive flights from the origin airport. The distinguishable indication may be made by changing the presentation of airports on the destination map 205. The change in presentation may consist of changes or addition to color, highlighting, shading, bolding, underlining, italics, shadowing, capitalizing, symbols, or any other manner of distinguishably changing the presentation.

The types of flights received from the origin airport 203 may be, for example, non-stop, one-stop same plane, or connecting flights. A non-stop flight is a direct flight from one airport to another airport without any stops made during the flight. A one-stop same plane flight is a flight between two airports during which the passenger remains on the plane while the plane makes one stop at an intermediary airport and then continues on the flight to the destination airport. A connecting flight is a flight between two airports during which the passenger must change airplanes at at least one intermediary airport. Other embodiments may include other types of flights, for example, multiple-stop flights on the same plane, one-stop flights but on different planes, multiple-stop flights on different planes, etc.

Items of travel related information that may be selected by the end user 111 may include, for example, an airports button 241, an airlines button 231, a specific airline at any destination airport 221, or a first destination airport 211 thereby presenting a third map-based display, a single-trip map 212.

The airports button 241 which is an item of travel related information presented on the destination map 205 when selected, displays an airports summary 243. The airports summary 243 is a listing of travel related resources located at or near the origin airport 203. The travel related resources may include lodging, car rental, parking, public transportation, etc. The airports summary 243 may be used to access an airport services travel related resource where the end user 111 may obtain information, purchase travel related services, or use any other features offered by the airport services travel related resource 245.

The airlines button 231 is another item of travel related information presented on the destination map 205, which when selected displays an airlines summary 233. The airlines summary 233 may display a listing of travel related resources, airlines offering non-stop or one-stop same plane flights leaving from the origin airport 203 and airports at which the non-stop or one-stop same plane flights arrive. Other embodiments may also include listings of airlines offering connecting flights from the origin airport 203. The airlines summary 233 may be used to access an airline travel related resource 235 where the end user 111 may obtain flight information, purchase flights, purchase travel related services, or use any other features offered by the airline travel related resource 235.

Another item of travel related information presented on the destination map 205 and which may be selected is an airline at any destination airport 221. Selection of an airline at any destination airport 221 gives the end user 111 access to an airline travel related resource 223 of the selected airline. The end user 111 may obtain flight information, purchase flights, purchase travel related services, or use any other features offered by the airline travel related resource 223. Thus, the end-user 111 has accessed the airline travel related resource 223, for example, a reservation system of the selected airline, by making two selections. Each selection may be made by a click with a computer mouse. A first click may be for the origin airport 203 and a second click may be made for the airline at any destination airport 221. As a result of these two clicks, the end user 111 may not only gain access to the reservation system of the selected airline but to a part of the reservation system of the selected airline showing a desired type of flight, for example, among other things, non-stop flights, between the first click-selected origin airport 203 and the second click-selected airline at any destination airport 221.

Another item of travel related information presented on the destination map 205 that the end user 111 may select is a first destination airport 211, thereby presenting the third map-based display, the single-trip map 212. In this embodiment a trip is defined as a non-stop or one-stop same plane flight between two airports. The single-trip map 212 is similar to the destination map 205 as described above. Presentation of airports on the single-trip map 212 is changed to indicate the types of flights that the airports may receive from the first destination airport 211, and the airlines at the airports that may receive flights from the first destination airport. The end user 111 may then select a flights button 213, the airports button 241, the airlines button 231, or an airline at any destination airport 225. The travel related information presented in the listings may default to travel related information for the origin airport 203 and may be changed by the end user 111 to the first destination airport 211. In other embodiments the travel related information presented in the listings may default to travel related information for the first destination airport 211 and be changed by the end user 111 to the origin airport 203.

The flights button 213, when selected, displays a flights summary 215 which is predominantly a listing of non-stop or one-stop same plane flights from the origin airport 203 to the first destination airport 211. The flights summary 215 may also list airlines offering connecting flights from the origin airport 203 to the first destination airport 211. The end user 111 may select a specific airline shown on the flights summary 215. Selection of a specific airline gives the end user 111 access to an airline travel related resource 217 where the end user 111 may obtain flight information, purchase flights, purchase travel related services, or use any other features offered by the airline travel related resource 217.

The airports button 241, when selected, displays an airports summary 247 which now is a listing of travel related resources available at or near the origin airport 203. The travel related resources may include lodging, car rental, parking, public transportation, etc. The airports summary 247 may be used to access an airport services travel related resource 249 where the end user 111 may obtain information, purchase the travel related services, or use any other features offered by the airport services travel related resource 249. The end user 111 may change the airport on the airports summary 247 and select the first destination airport 211 and be presented with an airports summary 247 for the first destination airport 211. In other embodiments, the airports summary 247 may default to the first destination airport 211 and be changed by the end user 111 to the origin airport 203.

The airlines button 231, when selected, displays an airlines summary 237 which now displays a listing of airlines offering non-stop or one-stop same plane flights leaving from the first destination airport 211 and airports at which the non-stop or one-stop same plane flights arrive. Other embodiments may also include listings of airlines offering connecting flights from the first destination airport 211. The airlines summary 237 may be used to access an airline travel related resource 239 where the end user 111 may obtain flight information, purchase flights, purchase travel related services, or use any other features offered by the airline travel related resource 239. The end user 111 may change the airport from which the non-stop or one-stop same plane flights leave on the airlines summary 237 to the origin airport 203 thereby seeing an airlines summary 237 for the origin airport 203. In other embodiments the airlines summary 237 may default to the first destination airport 211 and be changed by the end user 111 to the origin airport 203.

Selecting an airline at any destination airport 225 gives the end user 111 access to the airline travel related resource 227 of the selected airline. The end user 111 may obtain flight information, purchase flights, purchase travel related services, or use any other features offered by the airline travel related resource 227.

At any time, the end user 111 may back up to a prior point in the method and proceed with selections applicable to the prior point.

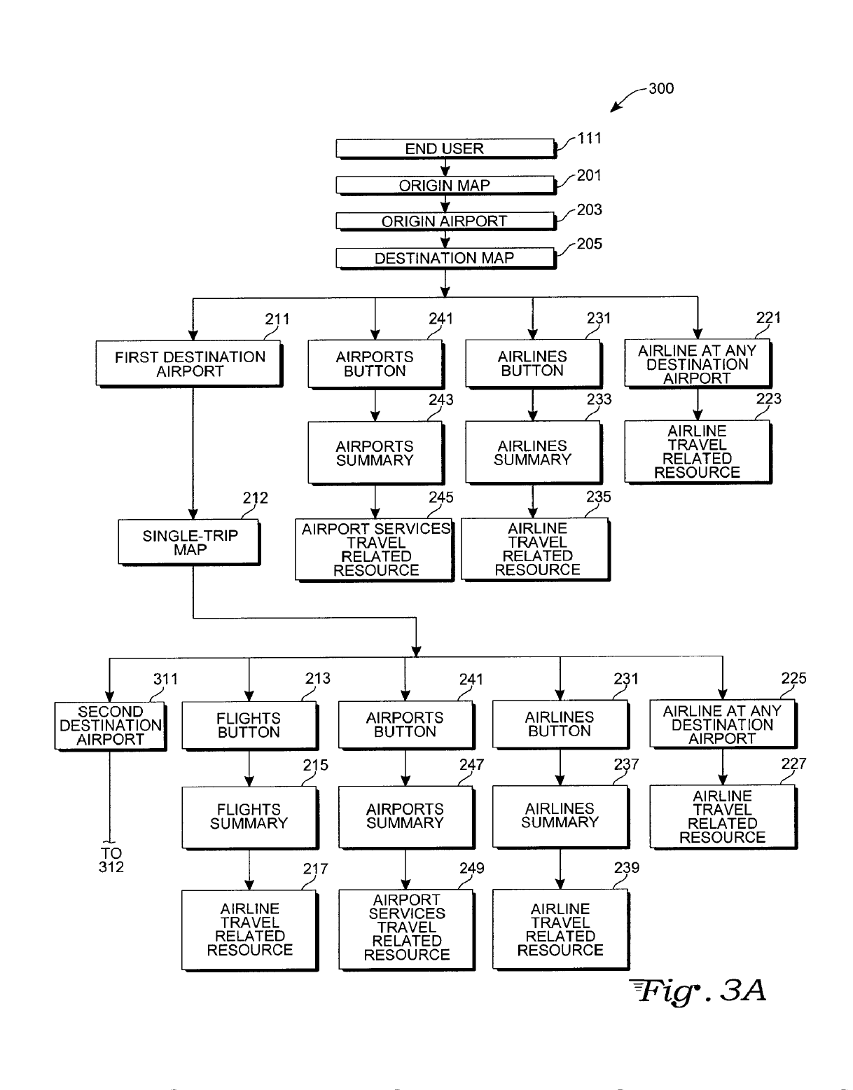

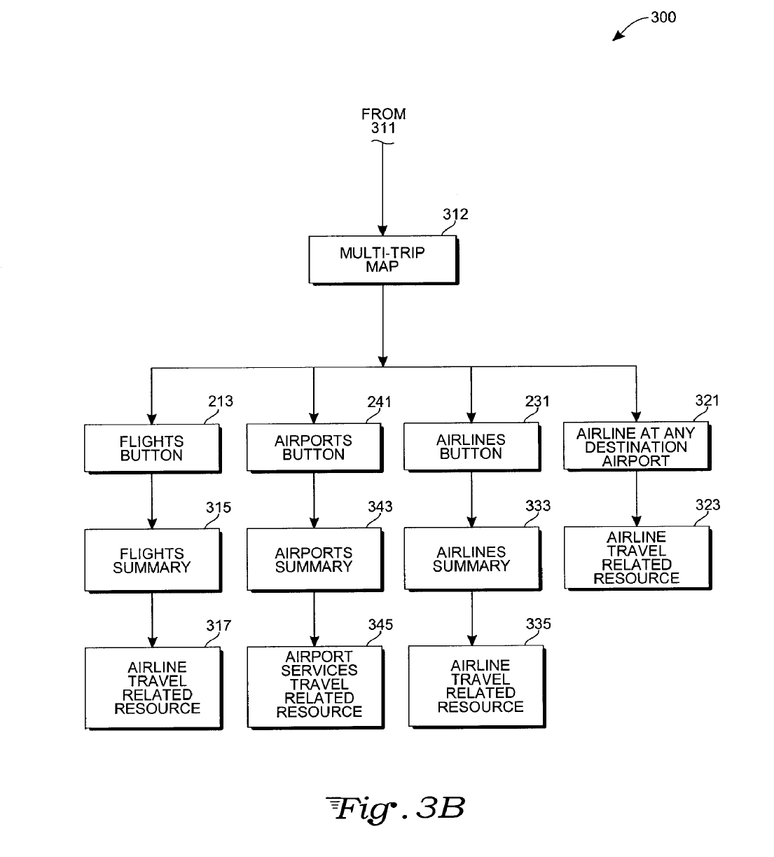

FIGS. 3A and 3B show an exemplary multi-trip flowchart 300 in accordance with the exemplary computer-based system and method of FIGS. 1 and 2. The end user 111 is presented with choices, map-based displays, and listings similar to those described above for the single-trip flowchart 200 of FIG. 2. The exemplary multi-trip flowchart 300 illustrates a two trip/three airport multi-trip, presented on a multi-trip map-based display, where the trips are connected. Other embodiments may have numerous trips and airports where some trips may be connected or some trips may be unconnected. Presenting numerous trips, multi-trips, may be accomplished by selecting additional destination airports thereby presenting new or updated multi-trip map-based displays.

The end user 111 is initially presented with similar choices for selection as described above for the single-trip flow chart 200. After the end user 111 selects the first destination airport 211, the single-trip map 212 is displayed as described above. The end user 111 may select a second destination airport 311 thereby causing the system to present a multi-trip map-based display, a multi-trip map 312, where the first destination airport 211 now becomes an originating airport for the second destination airport 311.

After selecting the second destination airport 311 the end user 111 may select the airports button 241, the airlines button 231, an airline at any destination airport 321, the flights button 213, or an airport presented on multi-trip map 312. The listings presented are similar to the listings presented in the single-trip flow chart 200 (FIG. 2). The travel related information presented in the listings may default to travel related information related to the airport selected for the first destination airport 211 or the second destination airport 311 or the origin airport 203. The end user 111 may change the airport presented in the listings to see travel related information for an airport other than the default airport.

The end user 111 may select the flights button 213. The flights button 213 when selected displays a flights summary 315 which is a listing of non-stop or one-stop same plane flights from the first destination airport 211 to the second destination airport 311. The flights summary 315 may also list airlines offering connecting flights from the first destination airport 211 to the second destination airport 311. The end user 111 may select a specific airline shown on the flights summary 315. Selection of a specific airline gives the end user 111 access to an airline travel related resource 317 where the end user 111 may obtain flight information, purchase flights, purchase travel related services, or use any other features offered by the airline travel related resource 317.

The airports button 241, when selected, displays an airports summary 343 which is a listing of travel related resources available at or near the second destination airport 311. The travel related resources may include lodging, car rental, parking, public transportation, etc. The airports summary 343 may be used to access an airport services travel related resource 345 where the end user 111 may obtain information, purchase travel related services, or use any other features offered by the airport services travel related resource 345. The end user 111 may change the airport on the airports summary 343 and select any of the other airports that are part of the multi-trip, thereby seeing an airports summary 343 for the newly selected airport.

The airlines button 231 when selected displays an airlines summary 333 which is a listing of airlines offering non-stop or one-stop same plane flights from the second destination airport 311 and airports at which the non-stop or one-stop same plane flights arrive. Other embodiments may also include listings of airlines offering connecting flights from the second destination airport 311. The airlines summary 333 may be used to access an airline travel related resource 335 where the end user 111 may obtain flight information, purchase flights, purchase travel related services, or use any other features offered by the airline travel related resource 335. The end user 111 may change the airport from which the non-stop or one-stop same plane flights leave on the airlines summary 333 and select any of the other airports that are part of the multi-trip thereby seeing an airlines summary 333 for the newly selected airport.

The end user 111 may select an airline at any destination airport 321 that is presented after the second destination airport 311 is selected. The end user 111 is then given access to an airline travel related resource 323 of the selected airline. The end user 111 may obtain flight information, purchase flights, purchase travel related services, or use any other features offered by the airline travel related resource 323.

At any time, the end user 111 may back up to a prior point in the method and proceed with selections applicable to the prior point. As mentioned above, the end user 111 is not limited to a two trip/three airport multi-trip. Nor is the end user 111 limited to connected multi-trips. Additional airports may be selected for the creation of additional trips whether connected or not.

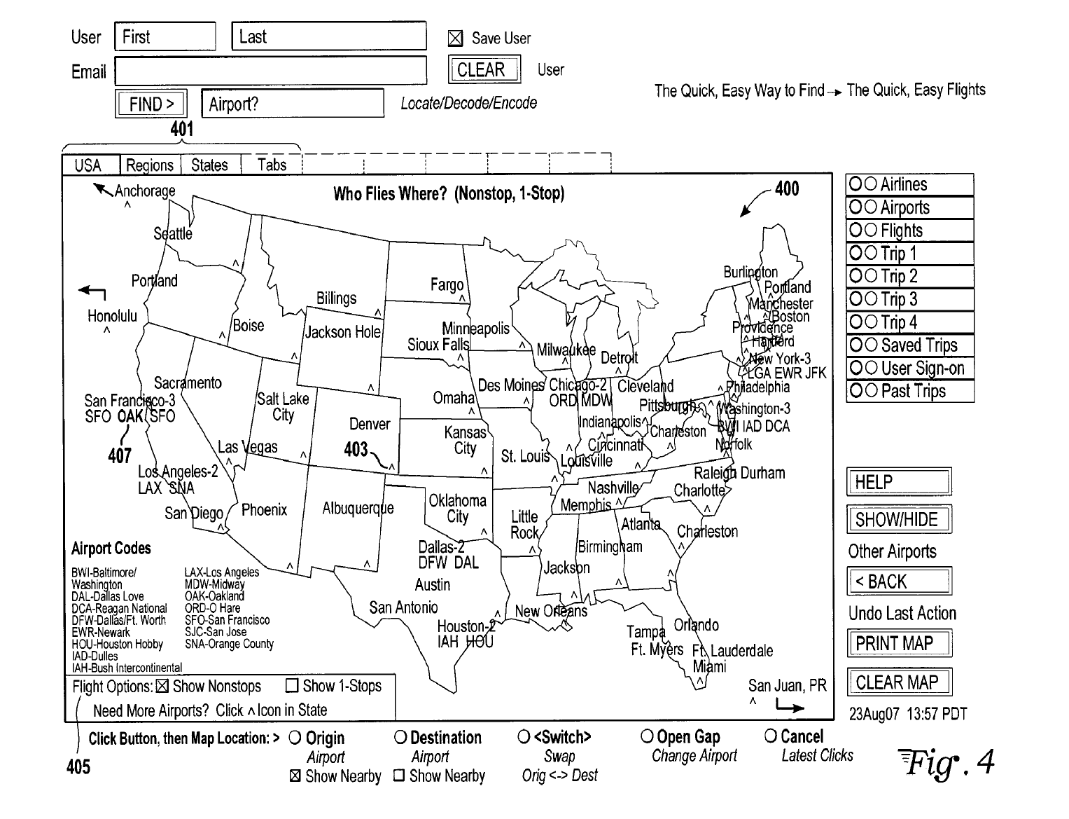

FIG. 4 is an exemplary first map-based display of travel related information on an origin map 400. The origin map 400 predominantly displays a geographic area with airports found in the geographic area from which a flight may originate. The geographic area and corresponding travel related information presented on the origin map 400 may be changed by selecting map display options 401 or a caret (“̂”) icon 403 (only one of which is numbered). This allows display of additional travel related information that is not conveniently presented on the origin map 400. Selecting map display options 401 or a caret (“̂”) icon 403 may allow at least one of the following: display of a different map-based display with its corresponding travel related information; presenting a list from which a different map-based display with its corresponding travel related information may be selected; presenting an expanded map-based display with its corresponding travel related information of a presented area; and a list of travel related information for an area from which an item of travel related information may be selected for display on the origin map 400.

Non-stop or one-stop same plane flights may be specified by selecting flight options 405. In this example the flight options 405 have been selected for non-stop flights thereby indicating non-stop airports on ensuing map-based displays and presenting non-stop travel related information in the ensuing examples. In other embodiments, one-stop same plane flights may be selected and then both non-stop and one-stop same plane flights are indicated on the ensuing map-based displays and travel related information for both non-stop and one-stop same plane flights are presented in the ensuing examples. The flight options 405 may be changed at any time and appropriate changes are made to map-based displays and travel related information. An origin airport may be chosen by selecting an origin airport 407, for example, Oakland (“OAK”).

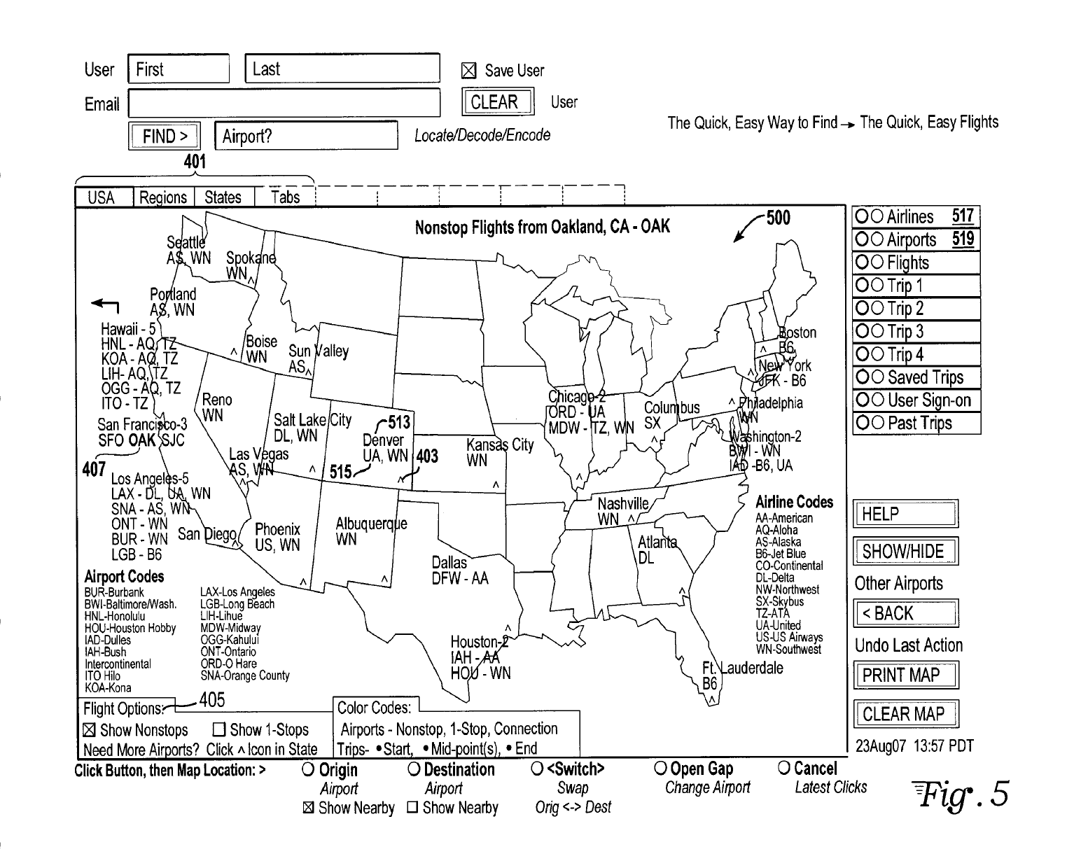

FIG. 5 is a destination map 500 which is an exemplary second map-based display of travel related destination information based on user input captured from the first map-based display. The travel related information presented on the destination map 500 is specific to selections and options made on the origin map 400 (FIG. 4). The destination map 500 predominantly displays a geographic area with the origin airport 407 and destination airports and airlines at the destination airports as described above for FIG. 2. Destination airports that receive non-stop flights from the origin airport 407 Oakland are distinguishably indicated. The geographic area presented in the destination map 500 may be changed by selecting the map display options 401 or a caret (“̂”) icon 403 as described above. Other items of travel related information that may be selected include, for example, flight options 405 as described above, an airlines button 517, an airports button 519, an airline 515 at a destination airport, for example (UA) United Airlines, or a first destination airport 513, for example Denver.

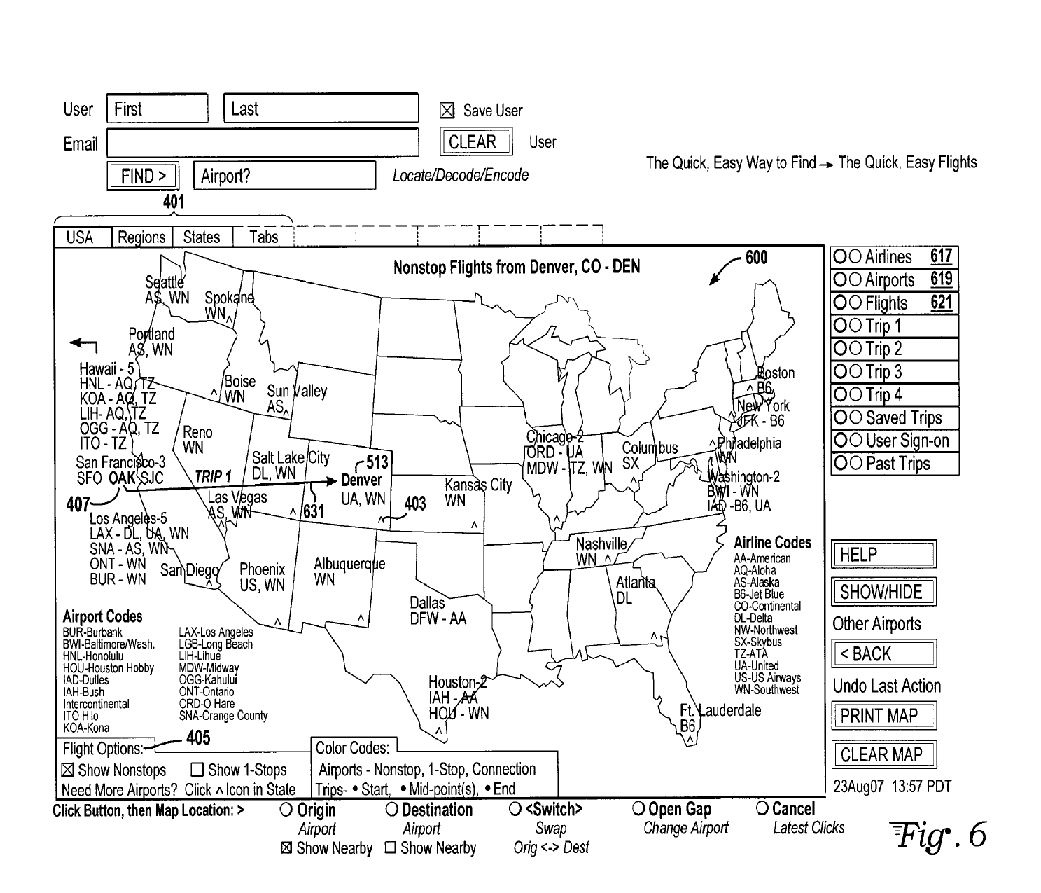

FIG. 6 is an exemplary third map-based display of travel related information, a single-trip map 600, based on user input captured from the second map-based display. The single-trip map 600 is presented when a specific airport, for example first destination airport 513, Denver, is selected as a destination airport from the destination map 500 (FIG. 5). As before, a trip may be defined as a non-stop or one-stop same plane flight between two airports, and in this example non-stop flights have been selected. The single-trip map 600 predominantly displays a geographic area with the origin airport 407, for example Oakland, the first destination airport 513, for example Denver, a first trip line 631 (trip 1) connecting the origin airport 407 to the first destination airport 513, and any other airports and airlines that may receive flights from the first destination airport 513 of Denver. The airports that may receive non-stop flights from the first destination airport 513 of Denver are distinguishably indicated. (For clarity on the single-trip map 600, airports and airlines that may receive a non-stop flight from the first destination airport 513 have not been changed significantly from the airports and airlines presented on the destination map 500.) The geographic area presented in the single-trip map 600 may be changed by selecting the map display options 401 or a caret (“̂”) icon 403 as described above. The single-trip map 600 also displays flight options 405 as discussed above, an airlines button 617, an airports button 619, and a flights button 621.

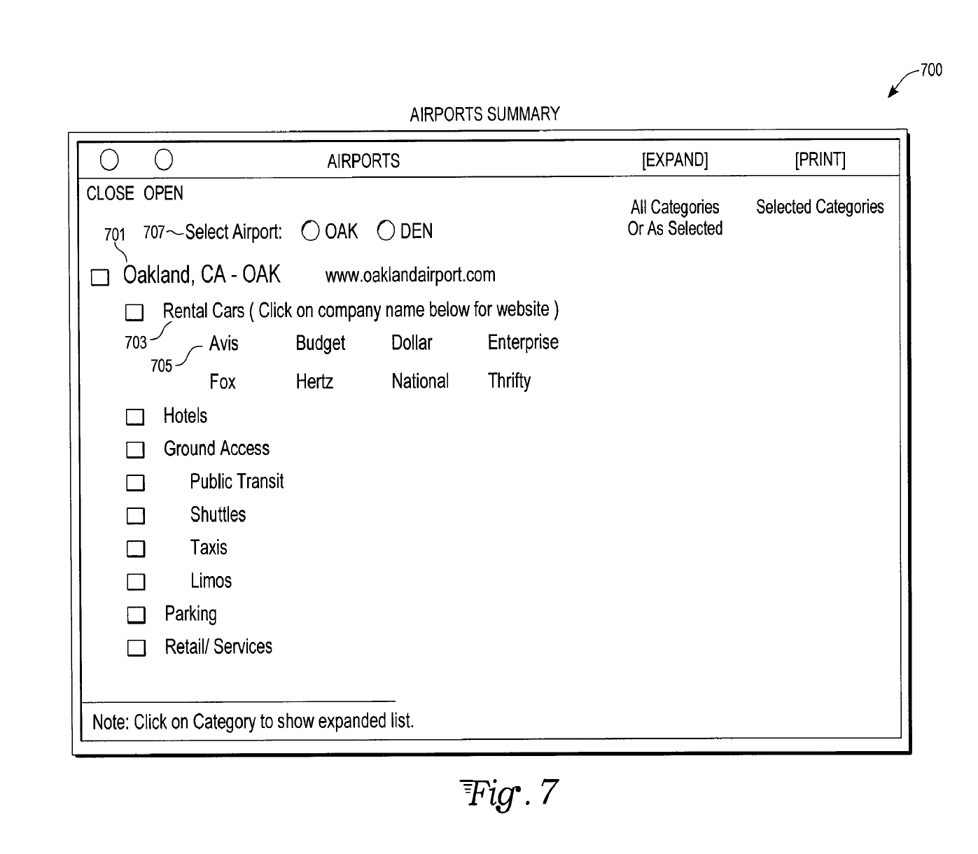

FIG. 7 is an airports summary which is a listing of travel related information detailing the travel related resources available at or near an airport. The airports summary 700 is presented when the airports button 619 (FIG. 6) is selected. The airports summary 700 lists types of travel related resources available at a specified airport 701, such as Oakland, and allows access to the listed travel related resources. One type of travel related resource may be for a rental car 703. A rental car 703 resource may be for example Avis® 705. Selecting, for example Avis® 705 permits access to Avis′® travel related resource where information may be obtained, travel related services may be purchased, or other features of Avis′® reservation system may be used. An airport specifier 707 is presented on the airports summary 700 which may be used to change the specified airport 701 Oakland, to select any of the airports comprising a trip, for example, on a single-trip map 600 (FIG. 6), thereby presenting travel related resources at or near the newly specified airport.

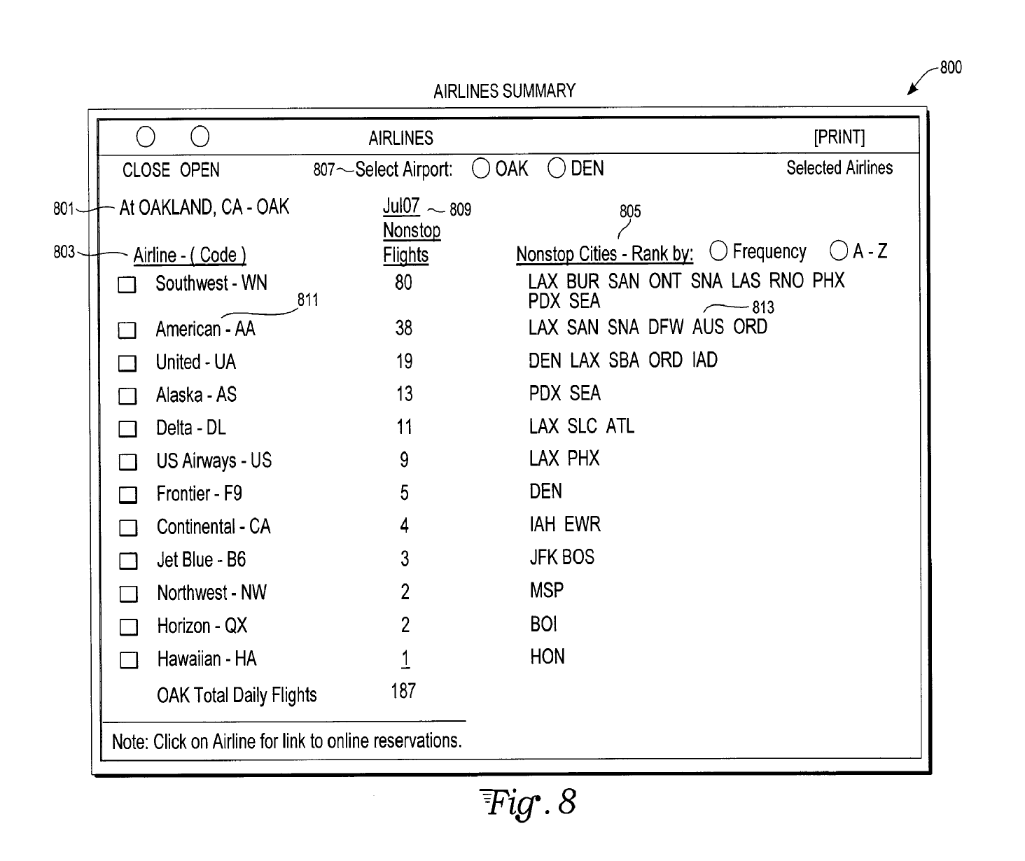

FIG. 8 is an airlines summary 800 which is a listing of travel related information presenting airlines offering non-stop flights from an airport and airports at which the non-stop flights arrive. The airlines summary 800 is presented when the airlines button 617 (FIG. 6) is selected. The airlines summary 800 lists travel related information about airlines 803 offering non-stop flights 809 from a specified airport 801 and the arrival airports 805 for non-stop flights 809. Selecting a specific airline, for example American Airlines®′ 811 permits access to American Airlines′® travel related resources where information may be obtained, flights may be purchased, travel related services may be purchased, or any other features of American Airlines′® reservation system may be used. In addition, selecting one of the non-stop arrival airports 805, such as AUS 813 (Austin), permits access to American Airlines′® reservation system showing flight information between the specified airport 801 and AUS 813 (Austin) which may include non-stop flights. An airport specifier 807 is available on the airlines summary 800 to change the specified airport 801 and specify any of the airports comprising a trip, for example, on a single-trip map 600 (FIG. 6), thereby presenting non-stop flights from the newly specified airport 801.

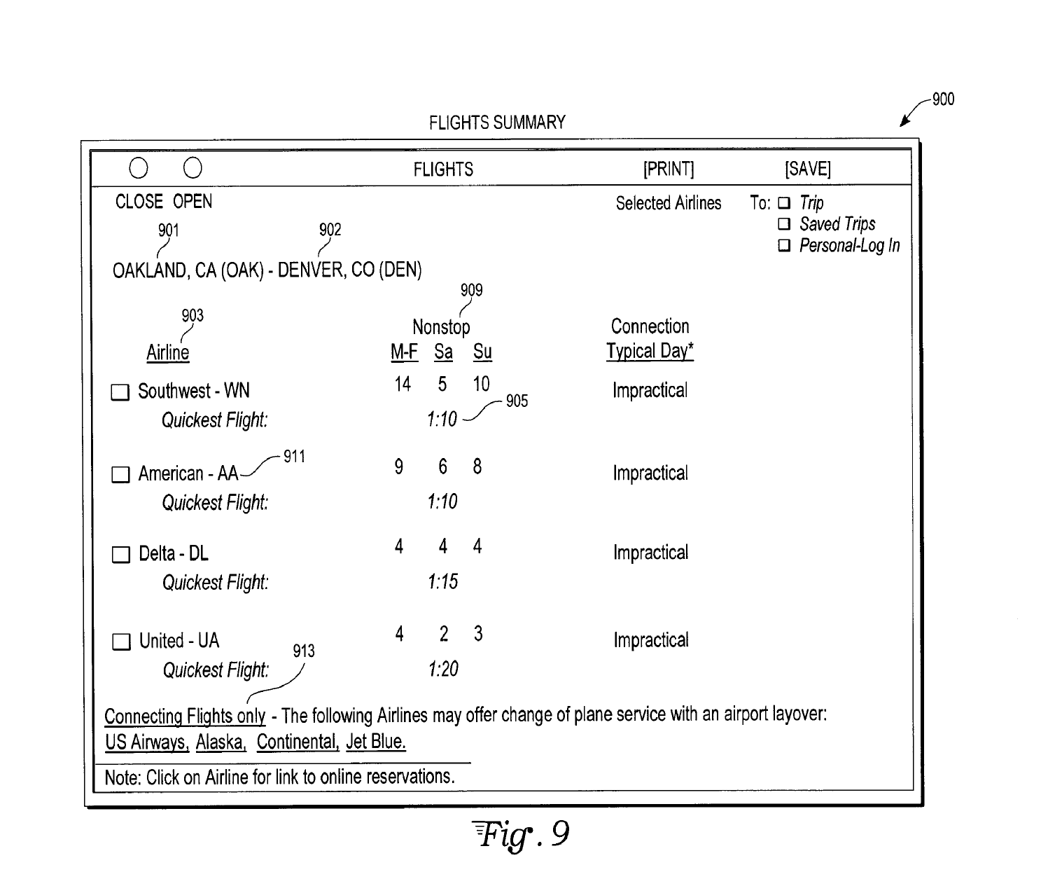

FIG. 9 shows a flights summary 900 which is travel related information presenting a listing of non-stop flights from an origin airport to a destination airport, The flights summary 900 is presented when the flights button 621 (FIG. 6) is selected. The flights summary 900 lists information about airlines 903 offering non-stop flights 909 from an origin airport 901 to a first destination airport 902 that are part of a trip. The listed information may include a quickest flight time summary 905 for each of the airlines 903 appearing on the flights summary 900. A specific airline may be selected, for example American Airlines® 911, which permits access to American Airlines′® travel related resources where information may be obtained, flights may be purchased, travel related services may be purchased, or other features of American Airlines′® travel related resources may be used. There is also a listing 913 of airlines offering connecting flights between the origin airport 901 and the first destination airport 902 from which a specific airline may also be selected permitting access to that airline's travel related resources.

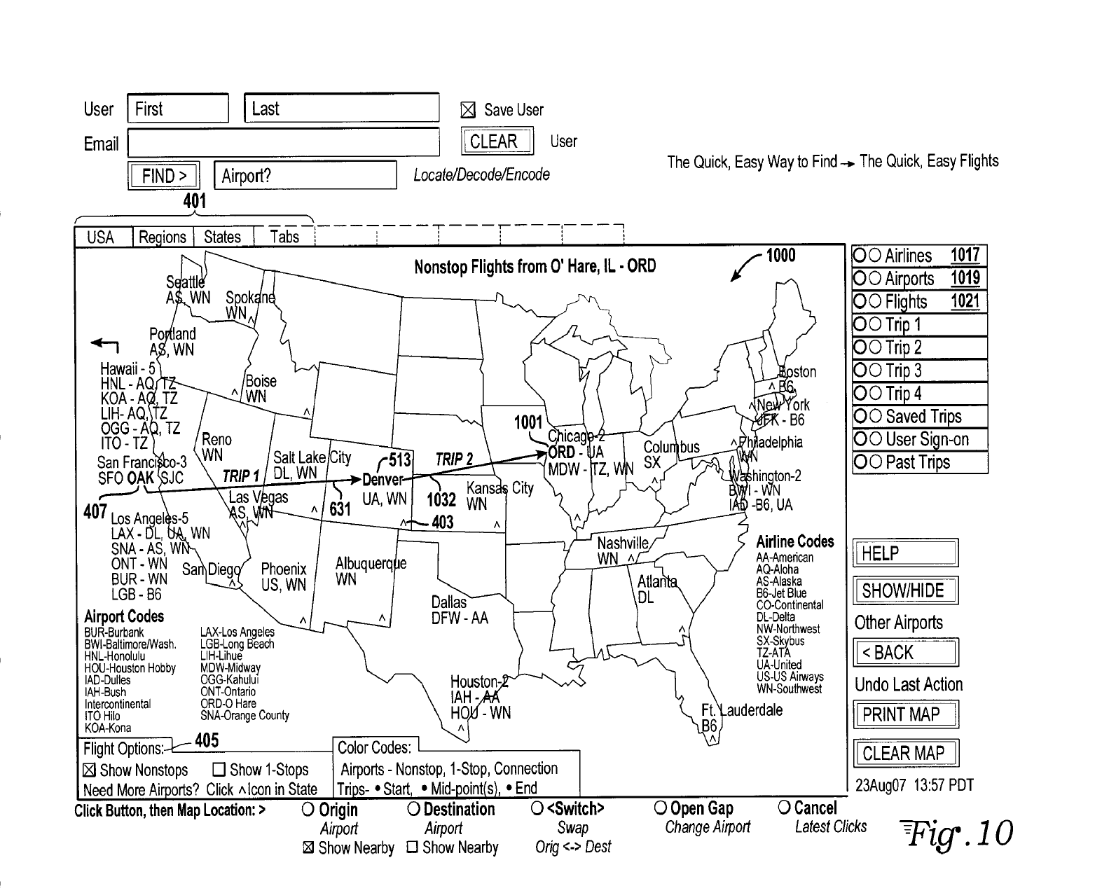

FIG. 10 is an exemplary multi-trip map-based display of travel related information, a multi-trip map 1000, based on user input captured from the third map-based display. Multi-trip maps are presented by continued selection of destination airports, for example, on the single-trip map 600 (FIG. 6) or the multi-trip map 1000. The multi-trip map 1000 results from selecting a second destination airport 1001(ORD O'Hare), on the single-trip map 600. The multi-trip map 1000 predominantly displays the airports selected for the trips, the trip lines connecting the airports selected for the trips, any other airports, and airlines at the any other airports that may receive flights from the most recently selected second destination airport (ORD O'Hare). Airports that may receive non-stop flights from the most recently selected destination airport are distinguishably indicated. (For clarity on the multi-trip map 1000, airports and airlines that may receive a non-stop flight from the second destination airport 1001 have not been changed significantly from the airports and airlines presented on the destination map 500 (FIG. 5) and the single-trip map 600.) The geographic area presented in the multi-trip map 1000 may be changed by selecting the map display options 401 or a caret (“̂”) icon 403 as described above.

Multi-trip map 1000 displays origin airport 407 Oakland, first trip line 631 (trip 1) connecting origin airport 407 Oakland to first destination airport 513 Denver, a second trip line 1032 (trip 2) connecting first destination airport 513 Denver to the most recently selected second destination airport 1001 (ORD, O'Hare). Multi-trip map 1000 also displays flight options 405 as discussed above, an airlines button 1017, an airports button 1019, and a flights button 1021. Items of travel related information which may be selected on the multi-trip map 1000 are similar to items of travel related information which may be selected on the single-trip map 600 (FIG. 6). These items of travel related information may include the airlines button 1017, the airports button 1019, the flights button 1021, or any potential destination airport or airline receiving flights from the second destination airport 1001 (ORD O'Hare). Airports that may receive non-stop flights from the most recently selected second destination airport 1001 (O'Hare) are distinguishably indicated. The functionality of the selections that may be made from the multi-trip map 1000 is similar to the single-trip map 600 that was described above for the single-trip map 600.

In the foregoing specification, the present invention has been described with reference to specific embodiments thereof. It will, however, be evident to a skilled artisan that various modifications and changes can be made thereto without departing from the broader spirit and scope of the present invention as set forth in the appended claims. For example, although a method of the present invention is described primarily in reference to map-based displays for presenting travel related information; skilled artisans will appreciate that the present invention may also be practiced with other types of displays and information. Specific embodiments are described above with reference to graphical user interfaces (map-based displays), listings, or features which may include windows, pointers, text boxes, icons, check boxes, buttons, computer mice, drop down lists, menus, etc. Persons of skill in the art will realize that embodiments may advantageously be implemented with other similar designs for a user interface. Selection of items presented by the map-based displays, listings, or other features may be made by using, for example, a computer mouse to move a pointer and click. Other embodiments may employ other means for making selections such as a touch screen, a touchpad, a pointing stick, a graphics tablet, eyeball control, or any other means. Further, principles embodied in the present invention may be beneficially applied to other types of overviews and information. The specification and drawings are, accordingly, to be regarded in an illustrative rather than a restrictive sense.

What is claimed is:

1. A computer implemented method of retrieving and presenting travel related information, the computer performing the following functions:
presenting a first map-based display of a plurality of airports; and
enabling via user interactions two airports, a first user interaction on one of the two airports being an origin airport on a second map-based display and a second user interaction on the other of the two airports being a destination airport on a third map-based display, wherein when the origin airport and destination airport are enabled a window is opened on the third map-based display that compares non-stop and one-stop same plane flights by all airlines on a route between the origin airport and destination airport with each airline listed separately.

2. The computer implemented method of claim 1 presenting in a single window on the third map-based display a comparative list of non-stop airlines between the origin and destination airports wherein a third user interaction on any of the listed non-stop airlines links the user with a booking site for an indicated non-stop airline.

3. The computer implemented method of claim 2 wherein the third user interaction in the window also provides the booking site with pre-populated input data for flight origin and destination based upon the first and second user interactions.
